(19) United States
(12) Patent Application Publication
(10) Pub. No.: US 2003/0152834 A1
(43) Pub. Date: Aug. 14, 2003

(54) Electrochemically active material for the negative electrode of a secondary electrochemical cell having an alkaline electrolyte

(75) Inventors: Patrick Bernard, Bordeaux (FR); Lionel Goubault, Merignac (FR); Laure Le Guenne, Bruges (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/349,949

(22) Filed: Jan. 24, 2003

(30) Foreign Application Priority Data
Jan. 31, 2002 (FR) 02 01 141

(51) Int. Cl. H01M 4/58; H01M 10/04

(52) U.S. Cl. 429/218.2; 429/232; 252/182.1; 29/623.1

(57) ABSTRACT

The present invention provides an electrochemically active material comprising a hydridable alloy whose surface is covered in a protective layer constituted mainly by a nickel hydroxide. The layer is preferably constituted by at least 80% by weight of nickel hydroxide and includes up to 20% by weight of at least one other metal which may be taken from Mn, Al, Co, Cr, Fe, and Cu. Also preferably, the layer represents 1% to 4% by weight of the hydridable alloy.

The present invention relates to an electrochemically active material for the negative electrode of a secondary electrochemical cell. It also extends to a method of manufacturing said active material, and to its use in a negative electrode of a secondary electrochemical cell having an alkaline electrolyte.

### BACKGROUND OF THE INVENTION

Negative electrodes of the “paste” type as used industrially in nickel metal hydride (Ni-MH) secondary electrochemical cells comprise a conducive support and paste, itself comprising a metal alloy capable of absorbing hydrogen to form a hydride and then of releasing the hydrogen in reversible manner. By way of example, such alloys are made up of misch metal, which is a mixture of rare earths, alloyed with transition elements (Ni, Co, Mn, Fe, etc. . . . ).

On contact with air, such hydridable alloys oxidize spontaneously, and their surface becomes covered in an oxide film that slows absorption of hydrogen. This results in a reduction of capacity and in an increase in the internal pressure of the cell. In order to restore the alloy to its initial activity, proposals have been made for various activation treatments serving to eliminate the oxide film, and, where possible, to prevent it from reforming.

Document EP-0 696 823 states that treatment with an alkaline solution at high temperature leads to the formation of needles of rare earth hydroxide, which needles can subsequently be eliminated by ultrasound. The presence of such needles reduces conductivity and shortens the lifetime of the cell. On the surface of an alloy containing transition metals of groups VIIa, VIII, or Ib of the periodic table, that document proposes enriching the surface layer in transition metals. That layer is obtained by elution of rare earths at the surface of the alloy with an acid aqueous solution of pH lying in the range 2 to 6.

Document EP-0 645 833 mentions treatments with water that is hot (>60° C.) or with an alkaline solution in order to form a nickel-based layer on the surface of the alloy. However, those treatments have the drawback of encouraging the formation of hydroxide. Hydroxide increases contact resistance between particles of hydridable alloy or reduces the activity of the alloy, thereby reducing performance during discharge at a high rate and at low temperature. That document therefore proposes acid treatment for the surface of the alloy. Acid treatment also has the effect of dissolving the surface of the alloy, giving off hydrogen. Unfortunately that hydrogen is immediately reabsorbed, giving rise to cracking in the surface of the alloy. To avoid that phenomenon, it is recommended to use an acid aqueous solution of pH that is maintained in the range 0.5 to 3.5.

Document EP-0 945 907 puts forward the opinion that conventional acid treatment does not prevent the alloy reoxidizing during fabrication of the cell. As a result, during charging, there is an increase in internal pressure in a sealed cell, capacity is low, and performance is poor when discharging at a high rate and at low temperature. That document proposes treating the alloy with an acid solution of pH lying in the range 0.5 to 3 in various implementations. In particular, an acid solution containing metal ions such as Ni or Co enables a metal surface layer to be formed. Once the pH reaches 4, an alkaline solution may be added to the acid solution so that the pH rises quickly to 5. The temperature of the solution is preferably at least 65° C. The rare earths dissolved in the solution during acid attack then deposit in hydroxide form on the surface of the alloy. The type of layer formed depends on the initial pH of the treatment solution. In particular, if the pH is too high, the layer formed will be too fine and too fragile for providing sufficient protection against oxidation.

The factor limiting lifetime for nickel metal hydride (Ni-MH) secondary cells is drying out of the separator which is a direct consequence of the hydridable alloy corroding in an alkaline medium. The consumption of water due to the corrosion reaction of the alloy causes the separator to dry out, which is responsible for an increase in the internal resistance of a sealed cell and thus for a decrease in electrochemical power. This corrosion generally gives rise to the capacity of the active material being reduced by a portion of the electrochemically active alloy being transformed into hydroxides and hydrides.

### OBJECT AND SUMMARY OF THE INVENTION

The object of the present invention is to propose a secondary electrochemical cell having a negative electrode whose active material comprises a hydridable alloy and which is of lifetime that is increased compared with known cells. Another object of the invention is to propose an electrochemically active material comprising a hydridable alloy which presents reduced corrosion in operation compared with prior art active materials. A further object of the invention is to propose a method of fabricating such an active material which is simpler to implement than known methods.

The present invention provides an electrochemically active material comprising a hydridable alloy whose surface is covered in a protective layer, the material being characterized in that said layer is constituted mainly by a nickel hydroxide.

The layer is preferably constituted by at least 80% by weight of nickel hydroxide. The layer may have up to 20% by weight of at least one other metal. This metal is selected in particular from Mn, Al, Co, Cr, Fe, and Cu.

The layer preferably constitutes 1% to 4% by weight of the hydridable alloy. Also preferably, the layer represents 2% to 4% by weight of the hydridable alloy in its initial state when used without prior treatment, and 1% to 3% by weight of the hydridable alloy after eliminating the oxide layer by prior treatment. This treatment may consist, for example, in moderate attack with an acid solution.

The MH hydridable alloy is selected from hydridable alloys of the AB₅ type in which A represents a misch metal Mm, which is a mixture of rare earths comprising in particular La, Ce, Pr, Nd, and Y, and in which B represents at least one element selected from Ni, Mn, Al, Co, Cr, Fe, Cu, B, Si, S, Cr, Ga, Ge, Mo, Ru, Rh, Pd, Ag, In, Sn, Sb, Bi, P, V, Nb, Ta, and W.

The invention also provides a negative electrode for a secondary electrochemical cell having an alkaline electrode, the electrode containing the above-described electrochemically active material. The electrode comprises a conducive support and a layer containing the active material and a binder. The binder is preferably selected from: a styrene and butadiene copolymer; and a styrene and acrylate copolymer. The conducive support may be a two-dimensional support such as a solid or perforated sheet, an expanded metal, a grid, or a fabric, or indeed it may be a three-dimensional support, such as a foam or a felt. The support is covered in a layer containing the electrochemically active material, a binder, and usually also a conductive material. The active material may also include small quantities of additives for facilitating shaping the electrode, such as a texture stabilizer or a thickener.

The invention also provides a secondary electrochemical cell having a negative electrode containing the above-described electrochemically active material. The cell further contains a positive electrode whose electrochemically active material is a nickel-based hydroxide, a polymer separator, and an alkaline aqueous electrolyte. The positive electrode may be of the sintered type or it may include a foam support. It may contain a hydroxide based on nickel, partially substituted by Co and/or Zn, a cobalt compound in the form of a conductive coating, and optionally a yttrium compound such as Y₂O₃. The electrodes are separated from each other by a separator of polyamide or of polyolefin, optionally treated with acrylic acid or a polysulfone.

The invention also provides a method of fabricating the above-described electrochemically active material, the method comprising the following steps:

suspending the hydridable alloy powder in water;

adding an aqueous solution of a nickel salt to said suspension;

then adding an alkaline solution so as to bring the pH to a value of not less than 7;

leaving said powder in contact with said alkaline solution; and

separating, washing, and drying said resulting active material powder.

The temperature of treatment in the presence of the alkaline solution is less than 100° C., and preferably less than 40° C. It is advantageous to operate at ambient temperature for reasons of convenience and expense. The nickel salt used is preferably a salt of nickel (II) such as, for example a nickel: acetate, sulfate, nitrate, or chloride. The alkaline solution may be a solution of sodium hydroxide NaOH, of lithium hydroxide LiOH, or of potassium hydroxide KOH. The powder is left in contact with the alkaline solution for a length of time that does not exceed 24 hours (h), and that preferably lies in the range 0 to 7 h.

For nickel metal hydride (Ni-MH) secondary cells that are for power applications or that are to operate at low temperature, prior acid treatment may be performed on the hydridable alloy in order to eliminate the surface oxide layer and increase performance. Unfortunately, that treatment increases the surface area of the alloy and consequently increases its corrosion level. It is therefore even more important to have available a method that leads to reduced corrosion of the hydridable alloy.

In a variant, the method of fabricating the above-described electrochemically active material comprises the following steps:

suspending the hydridable alloy powder in an acid aqueous solution in order to eliminate the oxide layer;

filtering and washing the deoxidized hydridable alloy powder, and then putting it into suspension in water;

adding an aqueous solution of a nickel salt to the suspension;

then adding an alkaline solution so as to bring the pH to a value of not less than 7;

leaving the powder in contact with the alkaline solution; and

separating, washing, and drying the resulting active material powder.

The acid temperature treatment is less than 100° C., and preferably less than 40° C. It is advantageous to operate at ambient temperature for reasons of convenience and expense. The acid aqueous solution has a pH of less than 7, preferably lying in the range 0 to 3. By way of example, a solution of hydrochloric acid HCl is used. The acid treatment is performed until the pH reaches the value of 3.

### BRIEF DESCRIPTION OF THE DRAWINGS

Other characteristics and advantages of the present invention appear from the following examples, naturally given in illustrative and non-limiting manner, and from the accompanying drawing in which:

FIG. 1 plots lifetime as number of cycles N of an electrochemical cell including a negative electrode containing an active material of the invention at a function of the quantity of hydroxide Q deposited on its surface expressed as a % by weight of hydridable alloy; and

FIG. 2 is analogous to FIG. 1 for an active material that has been subjected to prior acid treatment.

### MORE DETAILED DESCRIPTION

### EXAMPLE 1

An active material A was prepared using a hydridable alloy belonging to the AB₅ family having the following composition: La_{0.3}Ce_{0.5}Nd_{0.15}Pr_{0.05}Ni_{3.55}Mn_{0.4}Al_{0.3}Co_{0.75}. The active material was obtained by precipitating nickel hydroxide Ni(OH)₂ on said hydridable alloy in powder form. The outer layer of nickel hydroxide formed in that way constituted 1% of the mass of the alloy. The active material was prepared as follows.

The following were added in succession to a suspension of 150 grams (g) of hydridable alloy powder in 100 milliliters (ml) of water at ambient temperature (about 20° C.): 28.7 ml of a solution of nickel sulfate NiSO₄.6H₂O at a concentration of 150 grams per liter (g/l); then progressively a 1M solution of sodium hydroxide NaOH such that the pH reached a value of 11. The powder was then left under stirring in contact with the alkaline solution for about 1 h. The resulting active material powder was then separated from the solution by filtering, and was washed and dried.

### EXAMPLE 2

An active material B was prepared by using the same hydridable alloy as in Example 1. The active material was obtained by precipitating nickel hydroxide Ni(OH)₂ on the hydridable alloy in powder form. The outer layer of nickel hydroxide formed in that way constituted 3% of the mass of the alloy. The hydroxide layer was deposited in the manner described in Example 1, except that 86 ml were used of a 150 g/l solution of nickel sulfate NiSO₄.6H₂O.

### EXAMPLE 3

An active material C was prepared using a hydridable alloy that was the same as in Example 1. The active material was obtained by precipitating the nickel hydroxide Ni(OH)₂ on said hydridable alloy in powder form. The outer layer of nickel hydroxide formed in this way constituted 6% by weight of the alloy. The hydroxide layer was deposited in the manner described in Example 1 except for the fact that 172 ml were used of a 150 g/l nickel sulfate solution NiSO₄.6H₂O.

### EXAMPLE 4

An active material D was prepared using a hydridable alloy analogous to that of Example 1 except that the surface layer of oxide was eliminated by treatment with an aqueous hydridable of hydrochloric acid HCl as follows.

13 ml of an aqueous solution of hydrochloric acid HCl at a concentration of 12 M were added to a suspension of 150 g of alloy powder in 150 ml of water at ambient temperature (about 20° C.). The particles were maintained in suspension under stirring until the pH had reached a value of 3. The deoxidized hydridable alloy powder was then separated from the solution, washed, and dried. The resulting attack ratio constituted 3.5% by weight of the initial mass of the alloy. The attack ratio is defined as the ratio of the mass of alloy that is attacked over the initial mass of the alloy.

The active material was obtained by precipitating nickel hydroxide Ni(OH)₂ on said deoxidized hydridable alloy in powder form. The outer layer of nickel hydroxide formed in that way constituted 0.5% of the mass of the alloy. The hydroxide layer was deposited in the manner described in Example 1 except that 14.3 ml were used of a 150 g/l nickel sulfate solution NiSO₄.6H₂O.

### EXAMPLE 5

An active material E was prepared using a hydridable alloy analogous to that of Example 1 except that the surface layer of oxide was eliminated by treatment with an aqueous solution of hydrochloric acid HCl in the manner described in Example 4. The resulting attack ratio constituted 3.5% by weight of the mass of the alloy.

The active material was obtained by precipitating nickel hydroxide Ni(OH)₂ on said deoxidized hydridable alloy in powder form. The outer layer of nickel hydroxide formed in that way constituted 2% of the mass of the alloy. The hydroxide layer was deposited in the manner described in Example 1 except that 57.3 ml were used of a 150 g/l nickel sulfate solution NiSO₄.6H₂O.

### EXAMPLE 6

An active material F was prepared using a hydridable alloy analogous to that of Example 1 except that the surface layer of oxide was eliminated by treatment in an aqueous solution of hydrochloric acid HCl in the manner described in Example 4. The resulting attack ratio constituted 3.5% by weight of the mass of the alloy.

The active material was obtained by precipitating nickel hydroxide Ni(OH)₂ on said deoxidized hydridable alloy in powder form. The outer layer of nickel hydroxide formed in that way constituted 4% of the mass of the alloy. The hydroxide layer was deposited in the manner described in Example 1 except that 114.7 ml were used of a 150 g/l solution of nickel sulfate NiSO₄.6H₂O.

### EXAMPLE 7

By way of comparison, an active material X was used constituted by a hydridable alloy belonging to the AB₅ family and having the following composition La_{0.3}Ce_{0.5}Nd_{0.15}Pr_{0.05}Ni_{3.55}Mn_{0.4}Al_{0.3}Co_{0.75}.

### EXAMPLE 8

By way of comparison, an active material Y was prepared using the hydridable alloy of Example 7. The active material Y was obtained by eliminating the surface layer of oxide by treatment with an aqueous solution of hydrochloric acid HCl in the manner described in Example 4. The resulting attack ratio constituted 3.5% by weight of the mass of the alloy.

Using active materials A to F of the invention and comparative active materials X and Y, sealed secondary electrochemical cells of the nickel metal hydride (Ni-MH) type were made in the AA format, having a nominal capacity C=1200 milliampere hours (mAh), as follows.

The negative electrode was made using a paste having the following composition by weight (expressed in % relative to the weight of the paste):

| | |
|---|---|
| electrochemically active material | 80.0% |
| binder: styrene/butadiene rubber (SBR) | 0.5% |
| conductor: carbon | 0.3% |
| thickener: hydroxyproplymethylcellulose (HPMC) | 0.2% |
| water: | 19.0% |

The viscosity of the paste was adjusted with water. The paste was introduced into the conductive support which was a nickel foam. The assembly was then dried in order to eliminate the water and then rolled to a porosity of 25% in order to obtain the electrode.

The conventional type positive electrode used a nickel-based hydroxide as its electrochemically active material. The conductive support of the positive electrode acting as a current collector was a nickel foam. The capacity of the negative electrode was greater than that of the positive electrode.

An electrochemical stack was constituted by the above-described positive electrode placed against the above-described negative electrode and insulated therefrom by a separator constituted by a non-woven fabric of polypropylene. The spiral-wound stack was inserted in a metal can and impregnated in an alkaline electrolyte in the form of an aqueous alkaline solution constituted by a mixture of 7.4N potassium hydroxide KOH, 0.5N lithium hydroxide LiOH, and 0.4N sodium hydroxide NaOH.

The cold performance of the electrochemical cells, which is indicative of the state of activation of the alloy, was evaluated under the following conditions:

Cycles 1 and 2: charge at 0.1 Ic for 16 h at 20° C., where Ic is the current needed to discharge the nominal capacity C of a secondary cell in 1 h, and then discharge at 0.2 Ic to a stop voltage of 1 volt (V).

Cycle 3: charge at Ic for 1.1 h at 20° C. and then discharge at Ic at 20° C. down to a stop voltage of 0.9 V.

Cycle 4: charge at Ic for 1.1 h at 20° C., stabilize at −10° C. for 3 h, and then discharge at Ic down to a stop voltage of 0.8 V.

The corrosion of the negative electrode alloy was evaluated after four cycles and after 600 cycles by inductively coupled plasma (ICP) emission spectrometry of the quantity of aluminum Al dissolved in the electrolyte, and then trapped by the positive electrode. All of the aluminum coming from the negative electrode becomes inserted in the positive electrode. By comparing the quantity of positive electrode aluminum with the initial quantity of aluminum contained in the alloy of the negative electrode, it is possible to calculate the corrosion ratio of the cell. The results obtained are summarized in the table below:

the quantity of hydroxide precipitated as a % by weight relative to the initial alloy;

the initial capacity Ci in Ah at Ic at 20° C. (cycle 3);

the ratio in % of the capacity discharged cold Cd over the initial capacity Ci (cold discharge being at Ic and at −10° C., cycle 4);

the corrosion ratio T₄ in % after four cycles; and

the corrosion ratio T₆₀₀ in % after 600 cycles.

TABLE

| Active | | | | | | | | |
|---|---|---|---|---|---|---|---|---|
| material | A | B | C | D | E | F | X | Y |
| Treatment | NaOH | NaOH | NaOH | HCl + NaOH | HCl + NaOH | HCl + NaOH | — | HCl |
| Ni(OH)₂ (%) | 1 | 3 | 6 | 0.5 | 2 | 4 | 0 | 0 |
| Ci (Ah) | 1.260 | 1.255 | 1.245 | 1.280 | 1.275 | 1.270 | 1.275 | 1.284 |
| Cd / Ci (%) | 50 | 45 | 30 | 90 | 70 | 40 | 55 | 90 |
| T₄ (%) | 2.5 | 1.5 | 1 | 5.5 | 3 | 2 | 2.5 | 6 |
| T₆₀₀ (%) | 12.5 | 11.5 | 10.8 | 15.5 | 13 | 12 | 12.5 | 16 |

These results confirm that the initial capacity Ci of the hydridable alloy and its low temperature discharge performance are improved by acid treatment (Y compared with X), but the corrosion ratio increases significantly.

When the acid treatment is followed by alkaline treatment of the present invention, the corrosion ratio is less (D, E, F compared with Y), which is particularly visible after 600 cycles. The lowest corrosion ratios are obtained in the absence of acid treatment prior to the alkaline treatment of the invention (A, B, C compared with D, E, F).

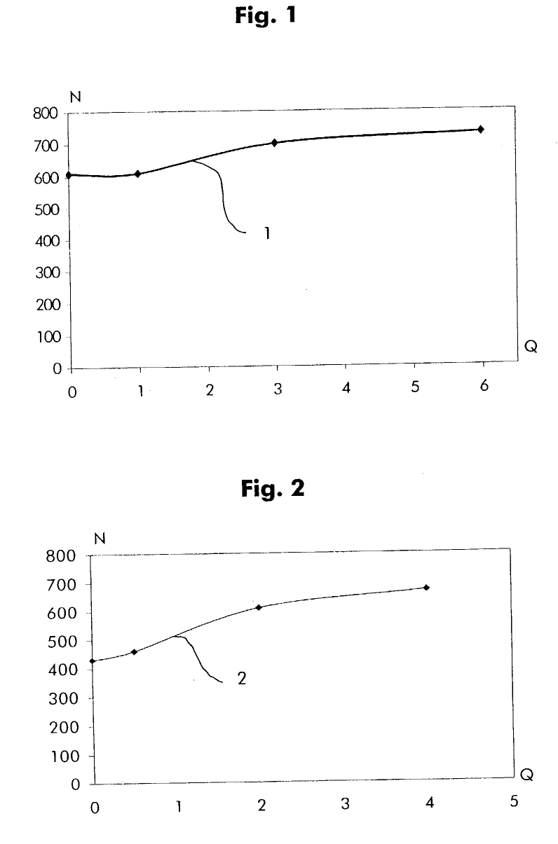

An evaluation of the lifetime of the electrochemical cells in high-rate cycling was performed under the following conditions, starting from cycle 5: charge at Ic for 1.1 h at 20° C., then discharge at Ic down to a stop voltage of 0.9 V. The end-of-life criterion selected was a critical corrosion ratio. Beyond the critical corrosion ratio, water consumption is accentuated by loss of hydrogen and consequently drying out of the separator is accelerated. The critical corrosion ratio is defined as the absence of excess negative capacity which contributes to a very fast rise in the rate of corrosion and consequently to a very fast rise in impedance. Excess negative capacity is determined by overdimensioning the capacity of the negative electrode relative to that of the positive electrode. This is necessary to avoid gaseous hydrogen H₂ being given off at the negative electrode when overcharging. The corrosion phenomenon leads to the-excess capacity of the negative electrode being consumed by the formation of hydrides and hydroxides. The results are shown in FIGS. 1 and 2.

Curve 1 in FIG. 1 shows the lifetime of an electrochemical cell as a function of the quantity of nickel hydroxide Ni(OH)₂ deposited on the surface of the hydridable alloy when the negative electrode contains an active material that has not been subjected to acid treatment (active materials X, A, B, and C). It can be seen that lifetime goes from 600 cycles for an active material constituted by an untreated hydridable alloy (X) to more than 700 cycles for an active material of the invention (C).

Curve 2 in FIG. 2 shows the lifetime of an electrochemical cell as a function of the quantity of nickel hydroxide Ni(OH)₂ deposited on the surface of the hydridable alloy for a negative electrode containing an active material that has been subjected to acid treatment (active materials Y, D, E, and F). When the oxide layer initially covering the surface of the hydridable alloy has been eliminated, it can be seen that lifetime goes from 400 cycles for an active material constituted by a hydridable of that has been subjected to acid treatment (Y) to nearly 700 cycles for an active material of the invention (F).

The consequence of reducing the corrosion ratio is thus a clear increase in the number of cycles for active materials that are analogous. The active material of the invention presenting simultaneously the highest capacity at low temperature, an corrosion ratio that is low, and long lifetime is active material B which was not subjected to prior acid treatment and which comprised 3% by weight of Ni(OH)₂.

Naturally, the present invention is not limited to the embodiments described, and it can be varied in numerous ways by the person skilled in the art without departing from the spirit of the invention. In particular, without going beyond the ambit of the invention it is possible to use a different hydridable alloy composition and to modify the composition of the nickel-based hydroxide and the nature of the doping elements. It is also possible to envisage using a conductive electrode support of different kind and structure. Finally, the various ingredients involved in making the paste, and the relative proportions thereof can be changed. In particular, the additives for facilitating shaping of the electrode, such as a texture stabilizer or a thickener, can be incorporated therein in minor amounts.

What is claimed is:

1. An electrochemically active material comprising a hydridable alloy whose surface is covered in a protective layer, wherein said layer is constituted mainly by a nickel hydroxide.

2. An active material according to claim 1, in which said layer is constituted by at least 80% by weight of nickel hydroxide.

3. An active material according to claim 1, in which said layer includes up to 20% by weight of at least one other metal.

4. An active material according to claim 3, in which said metal is selected from Mn, Al, Co, Fe, and Cu.

5. An active material according to claim 1, in which said layer represents 1% to 4% by weight of the hydridable alloy.

6. An active material according to claim 5, in which said layer represents 2% to 4% by weight of the hydridable alloy.

7. An active material according to claim 5, in which said layer represents 1% to 3% by weight of the hydridable alloy after the oxide layer has been eliminated.

8. An active material according to claim 1, in which said hydridable alloy is selected from hydridable alloys of the AB₅ type in which A represents a misch metal and B represents at least one element selected from Ni, Mn, Al, Co, Cr, Fe, Cu, B, Si, S, Cr, Ga, Ge, Mo, Ru, Rh, Pd, Ag, In, Sn, Sb, Bi, P, V, Nb, Ta, and W.

9. A negative electrode for a secondary electrochemical cell having an alkaline electrolyte, the electrode containing an electrochemically active material comprising a hydridable alloy whose surface is covered in a protective layer, constituted mainly by a nickel hydroxide.

10. An electrode according to claim 9, comprising a conductive support and a layer containing the active material and a binder, in which said binder is selected from a styrene and butadiene copolymer and a styrene and acrylate copolymer.

11. A secondary electrochemical cell having a negative electrode containing an electrochemically active material comprising a hydridable alloy whose surface is covered in a protective layer constituted mainly by a nickel hydroxide.

12. A cell according to claim 11, further comprising a positive electrode whose electrochemically active material is a nickel-based hydroxide, a polymer separator, and an alkaline aqueous electrolyte.

13. A method of fabricating an electrochemically active material comprising a hydridable alloy whose surface is covered in a protective layer constituted mainly by a nickel hydroxide, the method comprising the following steps:
suspending the hydridable alloy powder in water;
adding an aqueous solution of a nickel salt to said suspension;
then adding an alkaline solution so as to bring the pH to a value of not less than 7;
leaving said powder in contact with said alkaline solution; and
separating, washing, and drying said resulting active material powder.

14. A method according to claim 13, in which the temperature of treatment in the presence of said alkaline solution is less than 100° C.

15. A method according to claim 14, in which said temperature of treatment is less than 40° C.

16. A method according to claim 13, in which said nickel salt is a salt of nickel (II).

17. A method according to claim 16, in which said nickel salt is selected from a nickel: acetate; sulfate; nitrate; and chloride.

18. A method according to claim 13, in which said alkaline solution is selected from a sodium hydroxide solution NaOH, a lithium hydroxide solution LiOH, and a potassium hydroxide solution KOH.

19. A method according to claim 13, in which said powder is left in contact with said alkaline solution for a duration that does not exceed 24 hours.

20. A method of fabricating an electrochemically active material comprising a hydridable alloy whose surface is covered in a protective layer constituted mainly by a nickel hydroxide, the method comprising the following steps:
suspending the hydridable alloy powder in an acid aqueous solution in order to eliminate the oxide layer;
filtering and washing the deoxidized hydridable alloy powder, and then putting it into suspension in water;
adding an aqueous solution of a nickel salt to the suspension;
then adding an alkaline solution so as to bring the pH to a value of not less than 7;
leaving the powder in contact with the alkaline solution; and
separating, washing, and drying the resulting active material powder.

21. A method according to claim 20, in which the temperature of treatment in the presence of said acid solution is less than 40° C.

22. A method according to claim 20, in which said acid solution is a solution of hydrochloric acid HCl.

23. A method according to claim 20, in which said acid solution is of pH lying in the range 0 to 3.
